(19) United States
(12) Patent Application Publication
(10) Pub. No.: US 2002/0095063 A1
(43) Pub. Date: Jul. 18, 2002

(54) Method and device for positive ossicular fixation

(76) Inventors: Kai Kroll, Minneapolis, MN (US); Theodore P. Adams, Edina, MN (US); Donald L. Sturtevant, Vadnais Hieghts, MN (US); Clair Madsen, Maple Grove, MN (US)

Correspondence Address: Steven J. Keough, Fredrikson & Byron, P.A., 1100 International Centre, 900 Second Avenue South, Minneapolis, MN, 55402, US

(21) Appl. No.: 09/759,750

(22) Filed: Jan. 12, 2001

(51) Int. Cl. H04R 25/00

(52) U.S. Cl. 600/25

(57) ABSTRACT

A positive fixation device for use with a structure of mastoid, middle, or inner ear having engaging elements for engaging the ear structure and one or more resilient portions for adjusting the pressure of the engaging elements on the ear structure. The device is particularly useful in connecting the ear structure with a desired component, for example, a transducer.

### BACKGROUND OF THE INVENTION

1. Field of the Invention

This invention relates to a device for mounting components to a structure of the ear for use in a hearing aid system.

2. Description of Related Art

In a patient with normally functioning anatomical hearing structures, sound waves are directed into an ear canal by the outer ear and into contact with the tympanic membrane. The tympanic membrane is located at the terminus of the ear canal. The pressure of the sound waves vibrates the tympanic membrane resulting in the conversion to mechanical energy. This mechanical energy is communicated through the middle ear to the inner ear by a series of bones located in the middle ear region. These bones of the middle ear are generally referred to as the ossicular chain, which includes three primary components, the malleus, the incus and the stapes. These three bones must be in functional contact in order for the mechanical energy derived from the vibration of the tympanic membrane to be transferred through the middle ear to the inner ear.

Implantable devices are often useful for assisting with hearing. Such devices include partial middle ear implantable or total middle ear implantable devices, cochlear implants, and other hearing assistance systems that use components disposed in the middle ear or inner ear regions. These components may include an input transducer for receiving sound vibrations or an output stimulator for providing mechanical or electrical output stimuli based on the received sound vibrations. Piezoelectric transducers are one example of a class of electromechanical transducers that require contact to sense or provide mechanical vibrations. For example, the piezoelectric input transducer in U.S. Pat. No. 4,729,366, issued to D. W. Schaefer on Mar. 8, 1998, contacts the malleus for detecting mechanical vibrations. In another example the piezoelectric output transducer in the '366 patent contacts the stapes bone or the oval or round window of the cochlea.

Devices for assisting the hearing impaired patient range from miniaturized electronic hearing devices which can be adapted to be placed entirely within the auditory canal, or implantable devices which can be completely or partially implanted within the skull. For those hearing systems, or portions of hearing systems, that require complete subcranial implantation, a challenge has existed to adapt the implantable device for optimal mounting to the unique patient morphologies (including both naturally occurring as well as those created by surgical processes) among patients. Known implantable devices that have elements which perform a support or mounting function are typically rigidly mounted to a bone within the middle ear region. Difficulties have arisen with the use of implantable devices in facilitating the fine adjustments necessary to properly position and configure the support assembly and attached transducers so as to contact an auditory element and thus vibrate a portion of the ossicular chain. Such devices present a particular problem in that positioning, or docking, of the transducer against the auditory element in this stable configuration requires extremely fine adjustments that are difficult given the location of the auditory elements and the attendant's lack of maneuvering room.

A middle ear implantable hearing assistance system typically includes, at least, an input device, such as a sensor transducer, an output device, such as a driver transducer, and some means for electrically connecting the devices and coupling at least one device to an element of the middle ear. The device coupling the transducer to the middle ear element is a mechanical coupling. The transducer communicates with the middle ear element via the mechanical coupling. Thus, the mechanical coupling is critical in the efficacy of the hearing aid system. Proper positioning of the transducer and good contact between the transducer and ossicle is essential to properly transducing the received mechanical vibrations into a resulting electrical signal for hearing assistance processing. For example, there is a need in the art to ascertain whether too much force between the transducer and the ossicle, for example the malleus, can mechanically load the vibrating malleus and attenuate the desire mechanical vibration signal or alter its frequency characteristics. It may be likely that, in an extreme case, too much force can damage or break either the malleus or the transducer. It may also be likely that too little force between the transducer and the malleus may be insufficient to detect the mechanical vibration signal, and is more likely to result in a complete loss of signal detection if the transducer and the malleus become dissociated.

Positive fixation is when a device accommodates the morphology of the ossicle or tissue which it is connecting (directly or indirectly) as opposed to devices of the prior art which do not take into account the morphological differences of each patient. Such prior art devices either harm the patient by not taking into account, fully, the detrimental impact on tissue patency caused by its structural method of attachment, are nonfunctional, or lose functioning ability with drops of pressure. Specifically, when a transducer is too loosely coupled to the ossicle, there is no signal and, conversely, when a transducer is too tightly coupled to the ossicle, there may be a less than optimum frequency response or harm to the tissue.

Prior art coupling mechanisms used, for example, in coupling a transducer to an ossicle, have a variety of problems. Typically, adhesives, biasing, or crimping have been used to attach to an ossicle. Adhesives, while achieving positive ossicular fixation, have a limited lifespan in that their fixating ability deteriorates over time. Biasing may result in a connection which is too loose because of the difficulty in determining the extent of the biasing. Over a patient's lifespan, muscles, tissue, and ligaments may stretch and cause the biasing to become loose. Additionally, even if the biased element is not loose during everyday activity, it may become loose and lose contact altogether with a change in pressure, such as in an elevator or an airplane. Crimping has similar problems. It is difficult to determine when the element has been adequately crimped to the ossicle. If the element is too tightly crimped to the ossicle, the blood vessels lose patency and bone rotting to occur. If the element is too loosely crimped to the ossicle, there may be resonances and a poor frequency response.

Similar problems occur when coupling an ossicle to a passive prosthesis. A passive prosthesis is used when one or more of the malleus, incus, or stapes is partially or completely removed or damaged. The passive prosthesis maintains functional contact to transfer the mechanical energy derived from the vibration of the tympanic membrane through the middle ear to the inner ear.

There is no existing mechanical means for positive coupling with an ossicle without using an adhesive. Bands that are crimped to ossicles have proved to be unreliable and are normally fixed additionally with an adhesive.

The positive ossicular fixation device of the present invention can be used with implantable cochlear implants or with hearing aids.

### SUMMARY OF THE INVENTION

To address the difficulties noted above, it is an object of this invention to provide a device for more effectively and accurately positioning an element for contact with a structure of the ear. While reference is made explicitly to mounting a transducer to an ossicle, it should be apparent to those skilled in the art that the device could be used for coupling any desired device to an auditory element of the ear.

An apparatus for positive ossicular fixation of an ossicle in the middle ear is described. A transducer, for example, an electromechanical output transducer, converts electrical signals into mechanical vibrations. The electromechanical output transducer communicates these mechanical vibrations along a device coupled to an ossicular bone, for example the malleus or the incus. The present invention discloses an apparatus for improving the fixation of the coupling device between the transducer and the ossicular bone. The present invention utilizes a self-compensating subsystem for adjusting the connection of the coupling device on the ossicular bone.

### BRIEF DESCRIPTION OF THE DRAWINGS

FIG. 1 shows an embodiment of the positive ossicular fixation device configured for coupling with the malleus.

FIG. 2 shows a variation of the embodiment shown in FIG. 1 configured for receiving an installation tool.

FIG. 3 shows an alternate embodiment of the device configured for coupling with the malleus.

FIG. 4 shows an alternate embodiment of the device configured for coupling with the malleus.

FIG. 5 shows an alternate embodiment of the device configured for coupling with the malleus wherein the device involves a wire loop.

FIG. 6 shows an alternate embodiment of the device configured for coupling with the malleus wherein the device involves a wire loop.

FIG. 7 shows an alternate embodiment of the device configured for coupling with the malleus using a remote clamping mechanism.

FIG. 8 shows an alternate embodiment of the device configured for coupling with the malleus using a remote clamping mechanism.

FIG. 9 shows an alternate embodiment of the device configured for coupling with the malleus using a remote clamping mechanism.

FIG. 10 shows an alternate embodiment of the device configured for coupling with the malleus using a remote clamping mechanism deployed with a rod.

FIG. 11 shows an alternate embodiment of the device configured for coupling with the malleus using a remote spring clamping mechanism.

FIG. 12 shows an embodiment of the device configured for coupling with the stapes.

FIG. 13 shows an embodiment of the device configured for coupling with the stapes.

FIG. 14 shows an embodiment of the device configured for coupling with the stapes.

FIG. 15 shows an embodiment of the device configured for coupling with the stapes further configured for remote crimping.

FIG. 16 shows an embodiment of the device configured for use with a positive ossicular fixation device.

FIG. 17 shows an embodiment of a tool for measuring a structure in a human ear.

FIG. 18 shows an embodiment of a positive fixation device installation tool.

### DETAILED DESCRIPTION OF PREFERRED EMBODIMENTS

It will be understood that the drawings are intended to teach a preferred embodiment of the present invention but are not intended to limit the invention thereto.

The invention provides a device for positive ossicular fixation which is particularly advantageous when used in a middle ear implantable hearing system such as a partial middle ear implantable (P-MEI), total middle ear implantable (T-MEI), or other hearing aid system. A P-MEI or T-MEI hearing aid system assists the human auditory system in converting acoustic energy contained within sound waves into electrochemical signals delivered to the brain and interpreted as sound. The following is a description of a normal human auditory system. Sound waves are directed into an external auditory canal by an outer ear (PINNA). The frequency characteristics of the sound waves are slightly modified by the resident characteristics of the external auditory canal. These sound waves impinge upon a tympanic membrane (eardrum), interposed at the terminus of the external auditory canal, between it and the tympanic cavity (middle ear). Variations of the sound waves produce tympanic vibrations. The mechanical energy of the tympanic vibrations is communicated to the inner ear, comprising cochlea, vestibule, and semi-circular canals by a sequence of articulating bones located in the middle ear. This sequence of articulating bones is referred to generally as the ossicular chain. Thus, the tympanic membrane and the ossicular chain transform acoustic energy and the external auditory canal to mechanical energy at the cochlea.

The ossicular chain includes three primary components: a malleus, an incus, and a stapes. The malleus includes manubrium and head portions. The manubrium of the malleus attaches to the tympanic membrane. The head of the malleus articulates with one end of the incus. The incus normally couples mechanical energy from the vibrating malleus to the stapes. The stapes includes a capitulum portion, comprising a head and a neck, connected to a foot plate portion by means of a support crus comprising two crura. The stapes disposed in and against a membrane covered opening on the cochlea. This membrane-covered opening between the cochlea and middle ear is referred to as the oval window. Oval window is considered part of the cochlea in this patent application. The incus articulates the capitulum of the stapes to complete the mechanical transmission path.

Normally, tympanic vibrations are mechanically conducted through the malleus, incus, and stapes to the oval window. Vibrations at the oval window are conducted into fluid-filled cochlea. These mechanical vibrations generate fluidic motion, thereby transmitting hydraulic energy within the cochlea. Pressures generated in the cochlea by fluidic motion are accommodated by a second membrane covered opening of the cochlea. The second membrane covered opening between the cochlea and the middle ear is referred to as the round window. The round window is considered part of the cochlea in this patent application. Receptor cells in the cochlea translate the fluidic motion into neural impulses which are transmitted to the brain and received as sound. However, various disorders of the tympanic membrane, ossicular chain, and/or cochlea can disrupt or impair normal hearing.

Hearing loss due to an inability to conduct mechanical vibrations through the middle ear is referred to as a conductive hearing loss. Some patients have an ossicular chain lacking sufficient resiliency to transmit mechanical vibrations between the tympanic membrane and the oval window. As a result, fluidic motion in the cochlea is attenuated. Thus, receptor cells in the cochlea do not receive adequate mechanical stimulation. Damaged elements of the ossicular chain may also interrupt transmission of mechanical vibrations between the tympanic membrane and the oval window.

Implantable hearing aid systems have been developed, utilizing various approaches to compensate for hearing disorders. A particularly interesting class of hearing aid systems includes those which are configured for disposition principally within the middle ear space. The middle ear implantable (MEI) hearing aids, and electrical-to-mechanical output transducer couples mechanical vibrations to the ossicular chain, which is optionally interrupted to allow coupling of the mechanical vibrations to the ossicular chain. Both electromagnetic and piezoelectric output transducers have been used to communicate the mechanical vibrations to the ossicular chain. One example of a piezoelectric output transducer capable of communicating mechanical vibrations through the ossicular chain is disclosed in U.S. Pat. No. 4,729,366 issued to D. W. Schaefer on Mar. 8, 1988. In the '366 patent, a mechanical-to-electrical piezoelectric input transducer is associated with the malleus, transducing mechanical energy into an electrical signal, which is amplified and further processed. The resulting electrical signal is provided to an electrical-to-mechanical piezoelectric output transducer that generates a mechanical vibration coupled to an element of the ossicular chain or to the oval window or round window. In the '366 patent the ossicular chain is interrupted by removal of the incus. Removal of the incus prevents the mechanical vibrations delivered by the piezoelectric output transducer from mechanically feeding back to the piezoelectric input transducer.

A critical factor in the processing of sound through such a middle ear implantable system is the quality of connection between the transducers and the ossicular bones. A transducer can be coupled to the ossicular bone either directly or indirectly. Directly coupling a transducer to the middle bone involves biasing. Effectively biasing the transducer against an ossicular bond has proved problematic. The extent of the biasing is often difficult to determine, frequently resulting in loose biasing. It has been shown that a biased transducer will often become loose with a change in pressure, such as in an elevator or an airplane. Also even if the biasing is initially effective, muscles, tissue and ligaments may stretch and cause the biasing to become loose and the hearing aid to become temporarily nonfunctional. A transducer can be directly coupled to an ossicle with an adhesive to achieve temporary positive fixation. However, adhesives degrade over time and the transducer will eventually become unattached.

Transducers have also been coupled to ossicular bones indirectly using a coupling element crimped to the bone. The difficulty of determining the extent of crimping makes crimping problematic. If the element is too tightly crimped to the ossicle, the blood vessels lose patency and bone rotting to occur. If the element is too loosely crimped to the ossicle, there may be resonances and a poor frequency response.

There is no existing mechanical means to positively couple, for example, a transducer to an ossicle absent using an adhesive. To address the need for a mechanical means to positively couple a transducer to an ossicle without using an adhesive, the present invention utilizes a coupling device with a self-compensating subsystem.

The fixation device of the present invention is intended to engage an auditory element of the middle or inner ear to provide positive fixation to that element. The device may be used to couple the auditory element to a transducer, passive prosthesis, or any other desired structure.

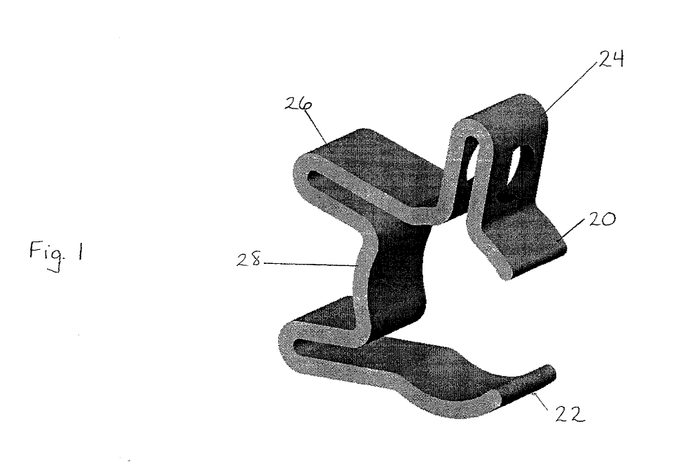

In FIG. 1, a fixation device is shown for engaging the malleus. The device can be constructed, for example, of a continuous strip of nitinol. Both ends of the strip are adapted to form engaging elements, 20 and 22. The distal portions of engaging elements, 20 and 22, are adapted for contacting the malleus. One engaging element, in this case 20, includes a housing, 24, adapted for receiving a probe tip. As shown in this embodiment, housing, 24, is a receiving ring. Housing, 24, could alternatively be a receiving channel or any other configuration adapted to receive a probe tip. The probe tip may be connected to any device which is desirable to couple to the malleus. Housing, 24, may be filled with a motion stabilizing means, for example a phase changing material, an adhesive, or other materials as know in the art, to stabilize the probe tip within housing, 24. The proximal ends of each engaging element, 20 and 22, form adjustment portions, 26, adapted for adjustment to effect adjustment of the distal portion of each engaging element in relation to the malleus. One way of adjusting adjustment portions, 26, is to clasp adjustment portions and press them towards one another so as to leverage engaging elements, 20 and 22, out from one another. Resilient portion, 28, extends between the adjustment portions, 26, and is adapted for setting the contact pressure of engaging elements, 20 and 22, on the malleus. Resilient portion, 28, may be, for example, a spring clamping mechanism or other spring-like formation.

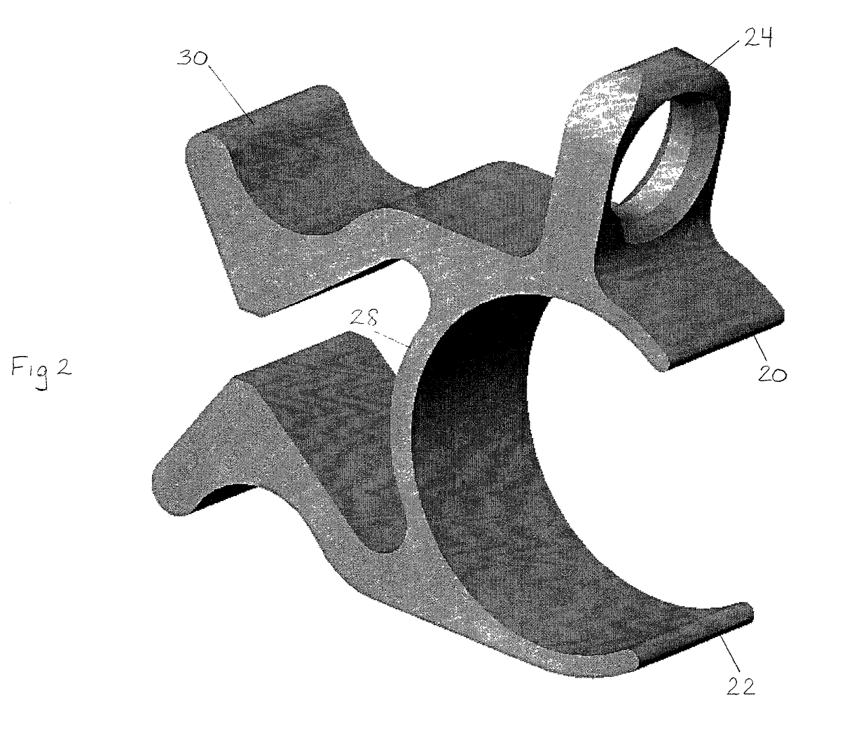

FIG. 2 is a slight variation of the embodiment shown in FIG. 1. Adjustment portions, 30, are configured for easy grip with a tool for compression to install the device. Specifically, adjustment portions are curved for receiving the tool and preventing the tool from slipping distally from the adjustment portions.

FIGS. 3-6 show a positive fixation device according to a modified embodiment that is, likewise, especially suitable for coupling to the malleus. FIG. 2 differs from FIG. 1 most especially in the configuration of the adjustment portions, 32. Where adjustment portions, 26, in FIG. 1 extend from engaging elements, 20 and 22, in a manner substantially along the entire cross-section of the engaging elements, adjustment portions, 32 in FIG. 3 extend from engaging elements, 20 and 22, only along one edge of engaging elements. This accommodates alternate tools for compression.

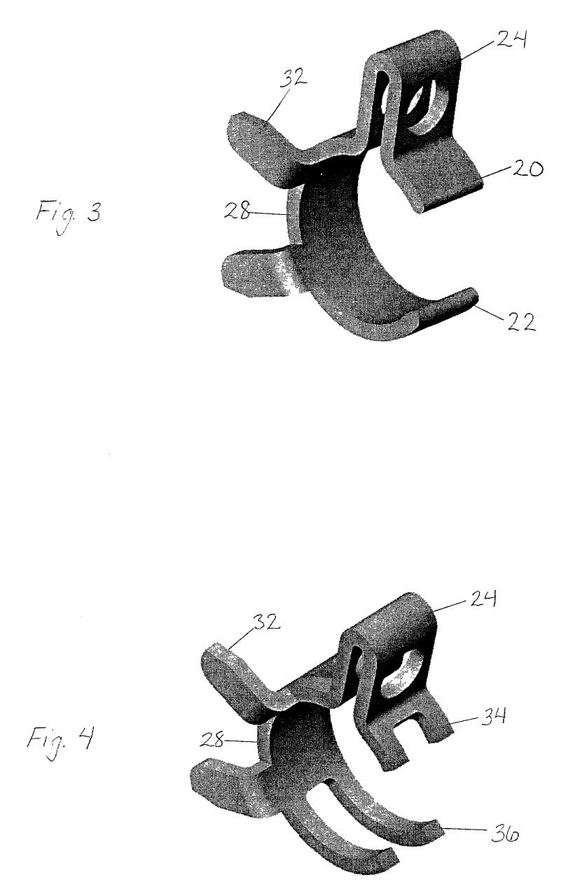

With particular reference to FIG. 4, it will be seen that engaging elements, 34 and 36, may be bifurcated to fit irregular surfaces. The bifurcation enhances tissue ingrowth by providing more surfaces around which the tissue to grow.

FIGS. 5-6 shows alternate embodiments of a positive fixation device suitable for coupling to the malleus that are formed of a continuous wire loop, manufactured, for example, of nitinol, press fit to a titanium element. In the continuous wire loop embodiments, the wire is itself resilient, obviating the need for an additional resilient element. With particular reference to FIG. 5, engaging element, 34, is bifurcated and project proximally into housing, 24, for receiving a probe tip. The engaging element, 34, and housing, 24 are manufactured of titanium or some other material suitable for welding. Engaging portion, 38, is the distal portion of a wire, 44, for example, nitinol. The proximal portion of the wire, 44, is formed into a wire loop, 42, adapted for adjustment of engaging element, 34, and engaging portion, 38, in relation to the malleus. Wire, 44, is connected to engaging element, 34, by way of a press fit bond, 40.

Turning now to FIG. 7-10, it will be seen that the engaging elements, may be resilient such that no additional resilient element needs to be utilized in order to achieve positive ossicular fixation, as seen specifically in FIG. 7. In such an embodiment, a clamping mechanism, 52, for example a ring, is deployed around and used for adjusting the distance between the engaging elements, 48 and 50. Due to their resiliency, the engaging elements, 48 and 50, are able to maintain their contact pressure on the ossicle. That is, should clamping mechanism, 52, cause engaging elements, 48 and 50, to contact the ossicle too forcefully, the resiliency of engaging elements, 48 and 50, will cause them to spring away from the ossicle to a less forceful contact pressure.

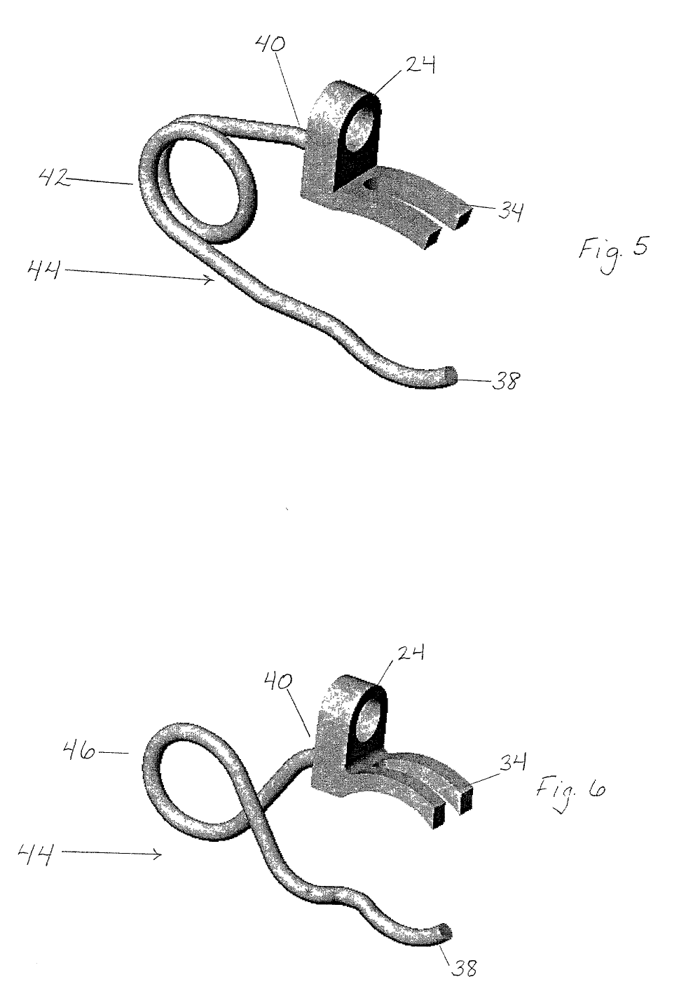

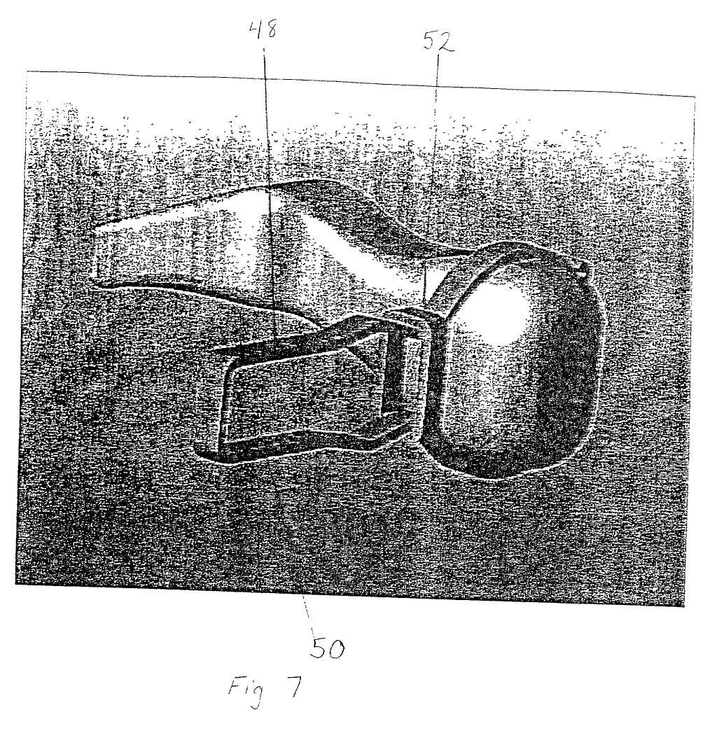

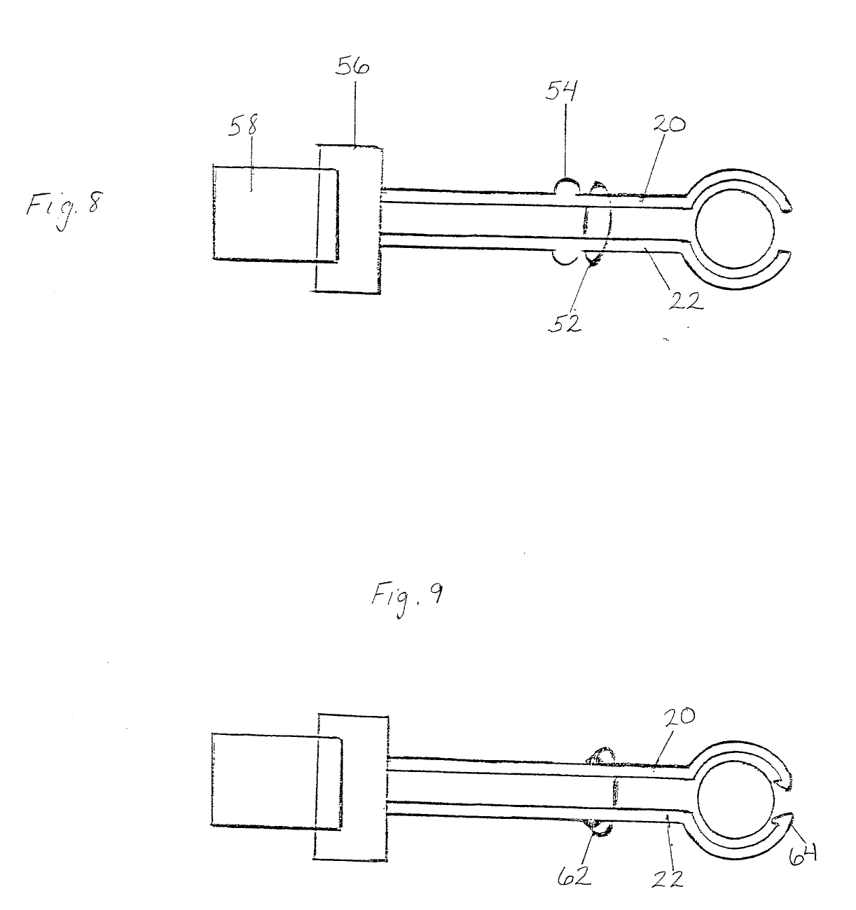

As seen in FIG. 8, there may be a deformation, 54, along engaging elements, 20 and 22, proximal to the clamping mechanism, 52. Deformation, 54, maintains the position of the clamping mechanism, 52. FIG. 8 also shows that engaging elements, 20 and 22, may directly contact with an encapsulant, 56. Encapsulant, 56, contacts and is in electrical connection with, for example, a transducer, 58.

As shown in the embodiment of FIG. 9, the clamping mechanism, 62, may be split to allow for crimping of the clamping mechanism on engaging elements, 20 and 22. Further, engaging elements, 20 and 22, may have a surface protrusion, 64, at their distal end to reinforce the grip of engaging elements, 20 and 22, around the ossicle and to inhibit slipping from the ossicle. Surface protrusion, 64, may be, for example, a pad.

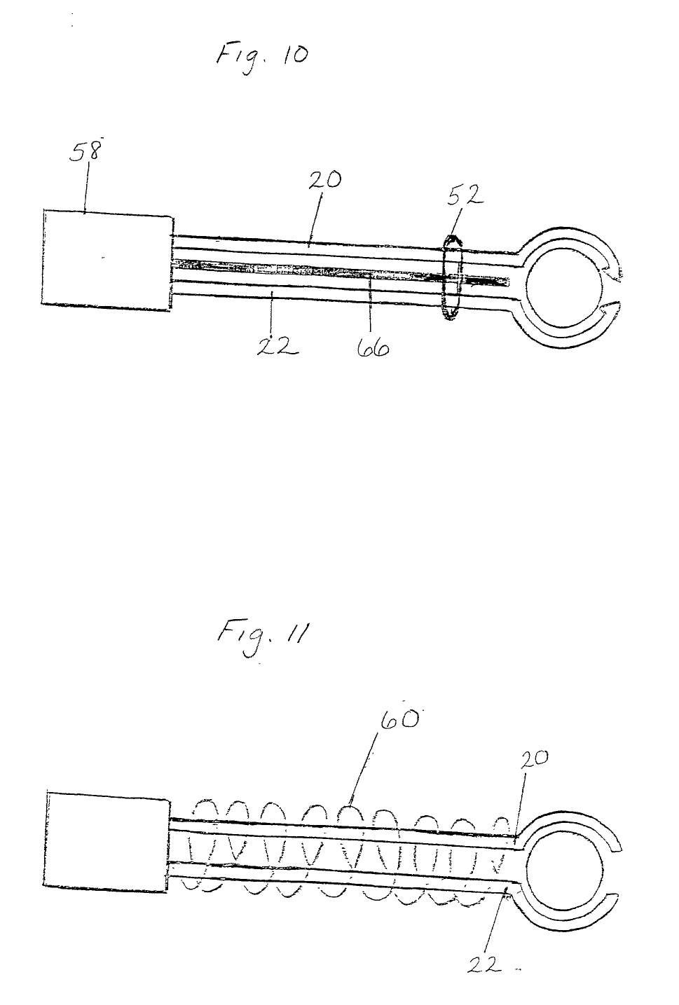

FIG. 10 shows a clamping mechanism, 52, that is a part of a continuous rod, 66, deployed parallel to engaging elements, 20 and 22. Continuous rod, 66, facilitates positioning of clamping mechanism, 52, along engaging elements, 20 and 22. As can also be seen in FIG. 9, engaging elements, 20 and 22, may be in direct contact with, for example, a transducer, 58.

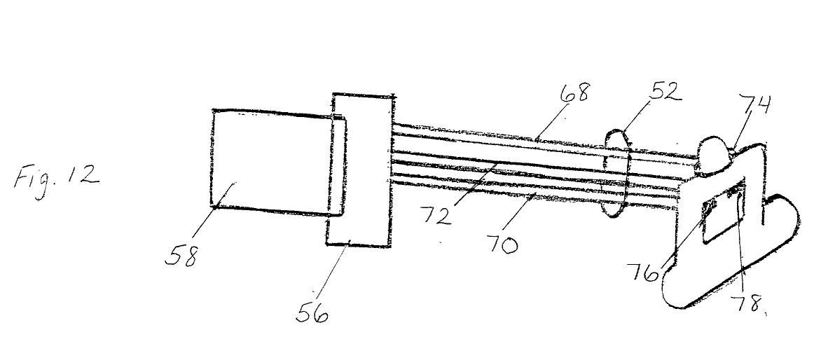

Turning now to FIG. 11, the resilient portion or the positive fixation device, may be a spring clamping mechanism, 60, deployed around engaging elements, 20 and 22. Additionally, spring, F3, may be preloaded and released with a trigger to contact engaging elements, 20 and 22, with the ear structure.

FIGS. 12-15 show particular embodiments of the positive ossicular fixation device designed for engaging the stapes. In FIG. 12, there are three engaging elements, 68, 72 an 74, for engaging the stapes. Each engaging element, 68-74, is resilient such that no further resilient element is needed to achieve positive ossicular fixation. Engaging element, 68, terminates in a ring, 74, for positioning around the stapes head. Engaging elements, 72 and 74, terminate in, for example, pads, 76 and 78, for engaging the bottom side of the capitulum of the stapes. A clamping mechanism, 52, is deployed around and used for adjusting the distance between the engaging elements, 68-74.

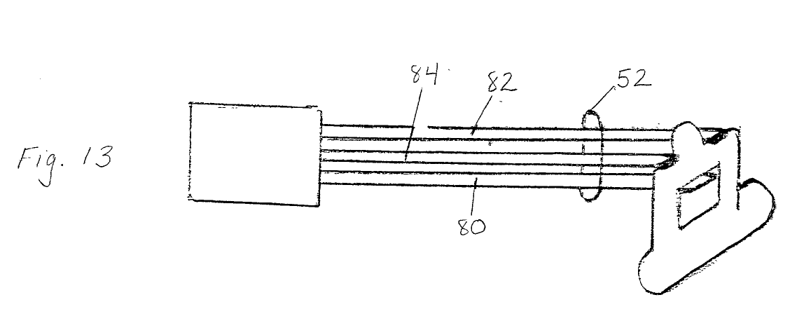

FIG. 13 shows a positive ossicular fixation device for engaging the stapes where, as in FIG. 12, there are three engaging elements, 80, 82 and 84. However, engaging elements, 82 and 84, engage both sides of the neck of the stapes instead of a ring fitting over the stapes head. Engaging element, 80, engages the bottom side of the capitulum of the stapes. As in FIG. 12, a clamping mechanism, 84, is deployed around and used for adjusting the distance between the engaging elements, 80-84.

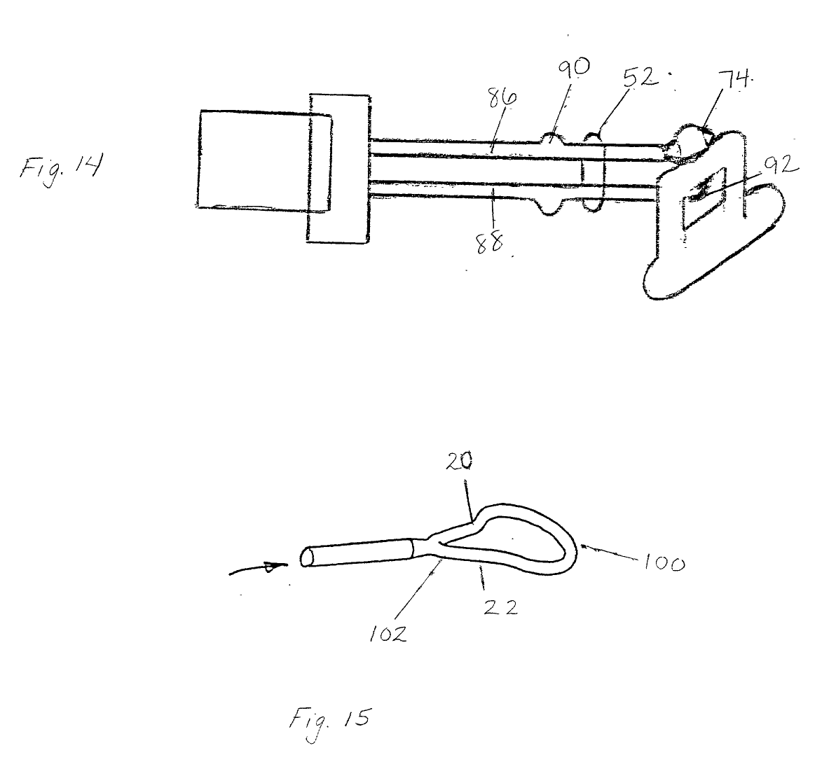

As seen in FIG. 14, two engaging elements, 86 and 88, may engage the stapes, rather than three. Engaging element, 86, terminates in a ring, 74, for positioning around the stapes head. Engaging element, 88, engages the bottom side of the capitulum of the stapes. The device further includes a deformation, 90, along engaging elements, 86 and 88, proximal to the clamping mechanism, 52. Deformation, 90, maintains the position of the clamping mechanism, 52.

Turning now to FIG. 15, it will be seen a single loop, 100, may engage the stapes. Engaging elements 20 and 22 are configured to end in loop 100. Loop 100 engages the stapes head. No additional resilient element needs to be utilized in order to achieve positive ossicular fixation. Remote crimping is done at or around location 102. By crimping remotely, force is not applied directly to the stapes head. In one embodiment, the device is manufactured of a material which is malleable and maintains an at least minimal level of resiliency.

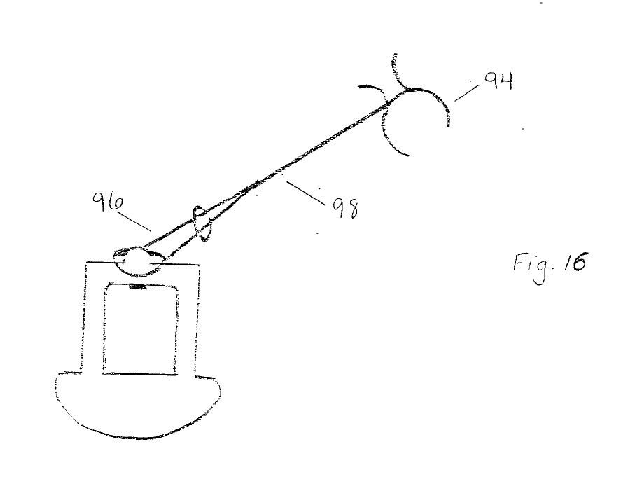

With particular reference to FIG. 16, the positive fixation device may be used with a passive prosthesis. The passive prosthesis may engage the stapes at one end and the incus or malleus at the other end. The positive fixation device may be used at either or both ends. The malleus or incus is engaged by a positive fixation device, 94, substantially as in FIGS. 1-4. However, it should be obvious that any of the positive fixation devices designed to engage the malleus or incus as described herein would be similarly effective. The stapes is engaged by a positive fixation device, 96, substantially as seen in FIG. 14. It should also be obvious that any of the positive fixation devices designed to engage the stapes as described herein would be similarly effective. A passive prosthesis, 98, joins the two positive fixation devices, 94 and 96.

FIG. 17 shows a sizing tool for use with measuring a structure in a human ear. The sizing system includes a shaft, 110, and a sizing zone, 112. Multiple sizing tools with sizing zones of multiple average human morphological bone sizes can be used to achieve a sizing system.

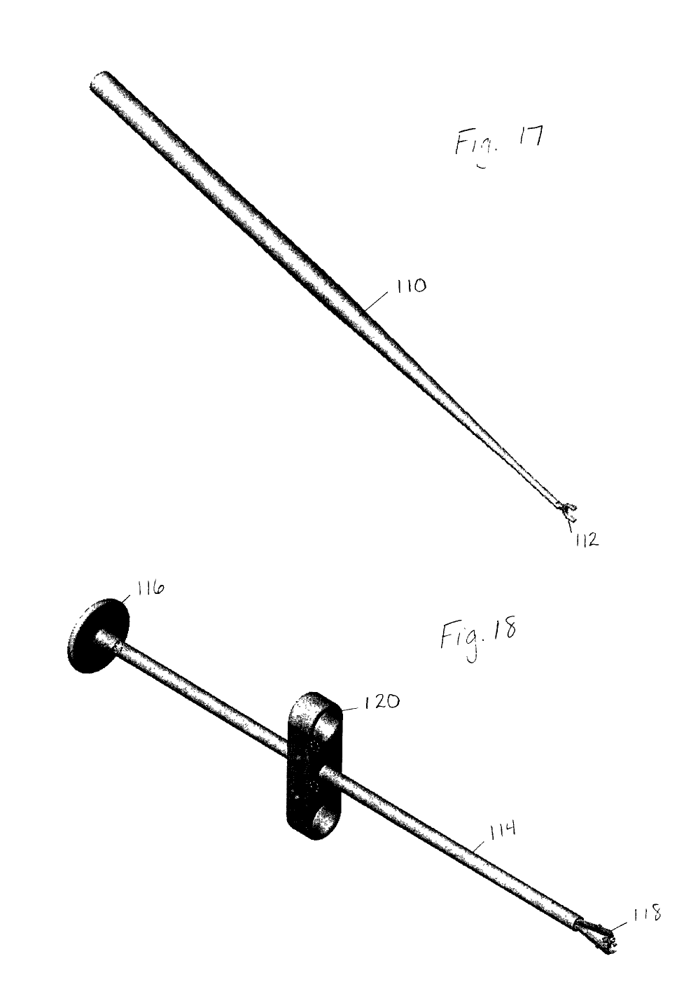

Turning now to FIG. 18, a positive fixation device installation tool may be used. The tool includes a tube, 114, having a thumb press, 116, at one end, and a clasp, 118 at the other end. Approximately mid-length along tube, 114, are finger grips, 120. Clasp, 118, is connected to a shaft within tube, 114. Tube, 114, moves along the shaft by direction of thumb press, 116. Pressure upon thumb press, 116, causes tube, 114, to be retracted, and clasp, 118, to release its grip.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. A hearing assistance device component for use with a structure of ear comprising:
a. component engaging portions for engaging the structure, and
b. one or more component resilient portions for maintaining the engaging portions in substantial contact with the structure.

2. The device of claim 1 wherein the ear structure is a structure of the middle ear, inner ear, or mastoid.

3. The device of claim 1 further including adjustment portions in communication with the engaging portions.

4. The device of claim 3 wherein the adjustment portions are configured for receiving a tool for positioning the device.

5. The device of claim 1 wherein the resilient portions are adapted for setting the contact pressure of each engaging portion on the ear structure.

6. The device of claim 1 wherein a portion of the device is manufactured of nitinol material.

7. The device according to claim 1 wherein the ear structure is an ossicular bone and the device couples the ossicular bone to another tissue structure within the ear.

8. The device according to claim 1 wherein the ear structure is an ossicular bone and the device couples the ossicular bone to an additional component of the device.

9. The device according to claim 1 wherein the ear structure is an ossicular bone and the device couples the ossicular bone to a microphone.

10. The device according to claim 1 wherein the ear structure is an ossicular bone and the device couples the ossicular bone to a transducer.

11. The device according to claim 10 wherein the transducer is a sensor.

12. The device according to claim 10 wherein the transducer is a driver.

13. The device according to claim 10 wherein the transducer is piezoelectric.

14. The device according to claim 10 wherein the transducer is electromagnetic.

15. The device of claim 10 wherein the device is indirectly coupled to a transducer.

16. The device of claim 15 wherein the device further comprises a housing adapted for receiving a probe tip from the transducer.

17. The device of claim 16 wherein the housing is filled with a motion stabilizing means to prevent movement of the probe tip within the housing.

18. The device of claim 16 wherein the housing is filled with a phase changeable material to prevent movement of the probe tip within the housing.

19. The device of claim 16 wherein the housing is a receiving channel.

20. The device of claim 16 wherein the housing is a receiving ring.

21. The device of claim 10 wherein the proximal end of each engaging element is coupled directly to the transducer.

22. The device of claim 10 wherein the device is permanently coupled directly to the transducer.

23. The device of claim 1 wherein the device is fabricated from a single strip of material.

24. The device according to claim 1 wherein the ear structure is an ossicular bone and the device couples the ossicular bone to a passive prosthesis.

25. The device according to claim 24 wherein the engaging elements engage the malleus.

26. The device according to claim 24 wherein the engaging elements engage the incus and the device is coupled either directly or indirectly to the stapes.

27. The device according to claim 24 wherein the engaging elements engage the stapes and the device is coupled either directly or indirectly to the incus.

28. The device according to claim 24 wherein the passive prosthesis, having an end coupled to the stapes and an end coupled to the incus, has engaging elements and resilient portions at both ends for engaging the incus and the stapes.

29. The device according to claim 1 wherein the resilient portion is a connection device having characteristics for connecting the engaging elements to one another at the ear structure.

30. The device according to claim 1 wherein the resilient portion is a spring clamping mechanism connected to the engaging elements.

31. The device of claim 30 wherein the spring is preloaded and released with a trigger to contact the engaging elements with the ear structure.

32. The device of claim 1 wherein an additional device component comprises a guide wire connected to at least one of the engaging portions or resilient portions for remote positioning of the device component.

33. The device of claim 1 wherein each engaging portion comprises a surface protrusion at its distal end to reinforce the grip of the engaging elements around the ear structure and to inhibit slipping from the ear structure.

34. A hearing assistance device component for use with a structure of ear comprising:
a. component engaging elements for engaging the ear structure, each engaging element having a proximal end and a distal end, wherein a portion of the proximal end of each engaging element is adapted for adjustment to effect adjustment of the distal portion of each engaging element in relation to the ear structure being engaged, and a portion of the distal end of each engaging element is adapted to contact the ear structure;
b. one or more component resilient portions for maintaining the engaging portions in substantial contact with the structure; and
c. adjustment portions in communication with the engaging portions.

35. The device of claim 34 wherein the engaging elements are bifurcated.

36. The device of claim 34 wherein the adjustment portions are configured for receiving a tool for positioning the device.

37. The device according to claim 34 wherein the resilient portion is built into the engaging elements such that each engaging element is resilient.

38. The device according to claim 37 wherein the engaging elements are formed of a continuous wire looped at the proximal end of the engaging elements in order to form the engaging elements extending therefrom.

39. The device according to claim 37 further comprising a clamping mechanism for adjustment of a distance between a portion of each engaging element.

40. The device according to claim 39 wherein the clamping mechanism functions to draw the engaging elements towards one another.

41. The device of claim 39 wherein the clamping mechanism is a ring.

42. The device of claim 41 wherein the ring is manufactured of nitinol material.

43. The device of claim 41 wherein the ring is split to allow for crimping to the engaging elements.

44. The device of claim 39 wherein a guide wire is run along the engaging elements for remote positioning of the clamping mechanism.

45. The device of claim 39 wherein the clamping mechanism is a part of a continuous rod deployed parallel to the engaging elements.

46. The device of claim 39 wherein each engaging element has an outward deformation proximal to the clamping mechanism to maintain the position of the clamping mechanism.

47. The device of claim 34 adapted for fixation to the stapes wherein the engaging elements are formed such that the topmost engaging element terminates in a ring adapted to capture the stapes head and the lowest engaging element is flat for positioning under the stapes head.

48. A clasping device for use with a structure of the middle ear comprising:
a. component engaging portions for engaging the structure;
b. one or more resilient portions connecting the engaging portions for maintaining the force of the engaging portions on the structure;
c. one ore more adjustment portions in contact with the engaging portions for adjusting the force of the engaging portions on the structure.

49. A clasping device for use with a structure of the middle ear comprising:
a. component engaging portions for engaging the structure, and
b. remote crimping portions for contacting the engaging portions in with the structure.

50. The device of claim 49, wherein the remote crimping portions are integral with the engaging portions.

51. A clasping device for use with the stapes comprising engaging elements terminating in a ring for positioning in contact with the stapes head, a portion of the engaging elements configured for remote crimping.

52. The device of claim 51 wherein the device is manufactured of gold.

53. The device of claim 51 wherein the device is manufactured of nitinol.

54. A self-compensating subsystem of a positive ossicular fixation device for use with an ossicle of a middle ear comprising a plurality of engaging elements for contacting the ossicle and one or more resilient elements cooperating with the engaging elements so that the force of contact of the engaging elements to the ossicle is maintained.

55. The subsystem of claim 54 wherein the engaging elements each have a proximal end and a distal end, wherein a portion of the distal end of each engaging element is adapted to contact the ossicle.

56. The subsystem of claim 54 wherein the resilient portion is a connection device having characteristics for connecting the engaging elements to one another at the ear structure.

57. The subsystem of claim 54 wherein a portion of the device is manufactured of nitinol material.

58. The device of claim 1 wherein the engaging portions are adapted for engaging the walls of the cochlea.

59. The device of claim 58 wherein the engaging portions are engaging elements and the resilient portions are incorporated into the engaging elements.

60. The device of claim 59 wherein the engaging elements are of approximately equal length.

61. The device of claim 59 wherein the engaging elements are of varied lengths.

62. The device of claim 58 wherein the device is deployed in a tubular element.

63. The device of claim 62 wherein the device expands resiliently outwardly to engage the walls of the cochlea upon exiting the tubular element.

64. A method of deploying a positive fixation device comprising the steps of:
a. providing a positive fixation device having component engaging portions for engaging structure of the ear, and one or more component resilient portions for maintaining the engaging portions in substantial contact with the structure at a location suitable for use with a structure of the ear.
b. applying stress to resilient portions of the device;
c. engaging the engaging portions of the device with the structure;
d. resiliently setting the contact force of the engaging elements on the structure.

65. The method of claim 64 used for positively fixing the device to an ossicular bone.

66. The method of claim 64 further comprising the step of measuring the structure to be engaged by the engaging portions.

67. The method of claim 66 wherein the structure is measured with a mechanical sizing system.

68. The method of claim 66 wherein the structure is measured with a noninvasive imaging system for measuring morphology of a middle or inner ear comprising a power source, measuring means, data collection means, and a means for controlling the range of the system.

69. The method of claim 68 using ultrasound imaging.

70. The method of claim 68 using microwave imaging.

71. The method of claim 64 wherein the engaging portions of the device have proximal and distal ends and stress is applied to the resilient portion by engaging the proximal end of the engaging portions.

72. The method of claim 71 wherein the engaging portions are engaged with alligator clips.

73. The method of claim 72 further comprising the step of releasing the proximal end of the engaging portions from the alligator clips after engaging distal end of the engaging portions to the ear structure.

74. The method of claim 64 wherein stress is applied to the resilient portions by clamping the resilient portions with a clamping mechanism after engaging the engaging portions to an ear structure.

75. The method of claim 64 further comprising the steps of mounting a transducer for operable connection to an ear tissue structure and coupling the transducer to the device either directly or indirectly.

76. The method of claim 75 further comprising the step of reinforcing the transducer using an adhesive.

77. The method of claim 75 wherein the coupling is done by extending a probe tip from the transducer into a housing on the device.

78. The method of claim 77 wherein the housing is filled with a phase-changeable substance.

79. The method of claim 64 further comprising the step of testing the functionality of the transducer on the ear structure fixed to the device.

80. A sizing system for use with measuring a structure in a human ear comprising at least one sizing zone defined by surfaces having a first average morphology.

81. The system of claim 80 wherein the sizing zone is further defined by surfaces having a second average morphology.

82. The system of claim 81 wherein the sizing zone is defined by surfaces including more than two average morphologies.
